(19) United States
(12) Patent Application Publication
(10) Pub. No.: US 2026/0309198 A1
(43) Pub. Date: Oct. 8, 2026

(54) BALL RAMP DRIVE FOR ELECTROMECHANICAL BRAKE

(71) Applicant: ZF Active Safety US Inc., Livonia, MI (US)

(72) Inventors: Kraig E. Gerber, Plymouth Township, MI (US); Galus Chelaidite, South Lyon, MI (US)

(21) Appl. No.: 19/173,392

(22) Filed: Apr. 8, 2025

(51) Int. Cl. F16D 65/18; B60T 13/74; F16D 65/38; F16D 121/24; F16D 125/38; F16D 125/40

(52) U.S. Cl. CPC F16D 65/18; B60T 13/746; F16D 65/38; F16D 2065/386; F16D 2121/24; F16D 2125/38; F16D 2125/40

(57) ABSTRACT

A ball-ramp assembly for a vehicle brake having brake pads and a rotor includes a shaft rotatable about an axis. A ball ramp has a first ramp rotatable with the shaft and a second ramp aligned with the first ramp. Bearing balls are positioned between and engage the first and second ramps for transforming rotation of the first ramp into axial movement of the second ramp. A nut has a threaded connection with the second ramp with a lead of the threads of the nut being multiple times larger than a lead of the threads on the second ramp. The ball ramp has a first condition in which rotation of the shaft rotates the ball ramp to axially move the nut relative to the ball ramp for engaging the brake pads with the rotor and a second condition thereafter in which rotation of the shaft rotates the first ramp relative to the second ramp to axially move the second ramp and nut together relative to the first ramp for applying the vehicle brake.

### TECHNICAL FIELD

The present invention relates generally to electromechanical brakes and, in particular, relates to a ball-ramp drive for an actuator assembly of the electromechanical brake.

### BACKGROUND

Most vehicles are equipped with a brake system for slowing or stopping movement of the vehicle in a controlled manner. A typical brake system for a modern automobile or light truck includes a disc brake assembly for each of the front wheels as well as a disc brake assembly for each of the rear wheels. In some instances, the brake system is electromechanical and therefore uses an electrical power source to actuate subassemblies including an electric motor, a transmission and a ball ramp assembly to thereby actuate the service brake during typical or emergency events as well as to actuate the parking brake.

### SUMMARY OF THE INVENTION

In one example, a ball-ramp assembly for a vehicle brake having brake pads and a rotor includes a shaft rotatable about an axis. A first ramp is rotatable with the shaft and has multiple ramps. A second ramp is aligned with the first ramp and has multiple ramps identical in number and design to the multiple ramps on the first ramp. Bearing balls are provided between the first and second ball ramps, oriented opposed and coaxially to each other, and simultaneously engage the ramps in each first and second ball ramp. A spring or biasing member engages the second ramp and the rotatable shaft, thereby providing a force to maintain the first and second ramps and the bearing balls synchronized to each other, such that a certain pre-set torque level is required to cause relative rotation between the first and second ramps. When the first and second ramps rotate with respect to each other via the rolling bearing balls, the rotation is according to a “ball ramp thread”. The second ramp has a secondary threaded connection with a nut. This secondary threaded connection between the nut and the second ramp has a lead that is multiple times larger than the “ball ramp thread”. Rotation of the shaft, with a relatively low input torque in a first direction rotates both first and second ramps and the bearing balls together to axially move the nut through the secondary threaded connection until clamp force is generated. Further rotation of the shaft in the first direction requires greater input torque above the pre-set torque level, causing the nut and the second ramp to remain “locked” to each other via the secondary threaded connection, thus rotating the first ramp relative to the second ramp such that the bearing balls move up the ramps to axially move the nut together with the second ramp to apply the brake.

In another example, a ball-ramp assembly for a vehicle brake having brake pads and a rotor includes a shaft rotatable about an axis. A ball ramp has a first ramp rotatable with the shaft and a second ramp aligned with the first ramp. Bearing balls are positioned between and engage the first and second ramps for transforming rotation of the first ramp into axial movement of the second ramp. A nut has a matching, multi-start threaded connection with the second ramp with a lead of the threads of the nut being about 2 to about 6 times larger than a lead of the ball ramp. The ball ramp has a first condition in which rotation of the shaft rotates the whole ball ramp assembly to axially move the nut relative to the ball ramp for engaging the brake pads with the rotor and a second condition thereafter in which rotation of the shaft rotates the first ramp relative to the second ramp to axially move the second ramp and nut together relative to the first ramp for applying the vehicle brake.

Other objects and advantages and a fuller understanding of the invention will be had from the following detailed description and the accompanying drawings.

### BRIEF DESCRIPTION OF DRAWINGS

FIG. 1A is perspective view of a caliper assembly having an example ball ramp assembly in accordance with the present invention.

FIG. 1B is a first section view of a portion of a caliper housing of the caliper assembly of FIG. 1.

FIG. 2 is a second section view of a portion of caliper assembly illustrating the ball ramp assembly.

FIG. 3A is a section view of a representative, assembled ball ramp assembly of the actuator assembly.

FIG. 3B is an exploded view of the ball ramp assembly.

FIG. 4A is a schematic illustration of a first ramp of the ball ramp assembly.

FIG. 4B is a schematic illustration of the first ramp of FIG. 4A taken from the opposite side of FIG. 4A.

FIG. 4C is a section view of the first ramp of FIG. 4A taken along plane 4C-4C.

FIG. 5A is a schematic illustration of a second ramp of the ball ramp assembly.

FIG. 5B is a section view of the second ramp of FIG. 5A taken along line 5B-5B.

FIG. 5C is a top view of the second ramp.

FIG. 6 is a schematic illustration of a bearing ball cage of the ball ramp assembly.

FIG. 7 is a schematic illustration of the ball ramp assembly during a first stage of brake apply.

FIG. 8 is a schematic illustration of the ball ramp assembly during a second stage of brake apply.

### DETAILED DESCRIPTION

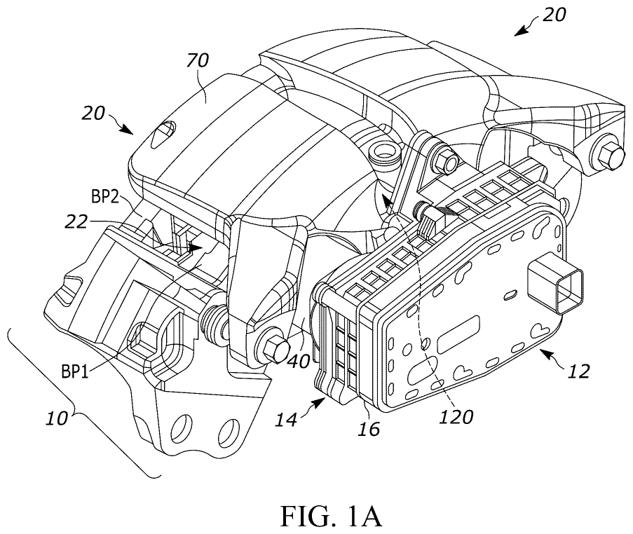

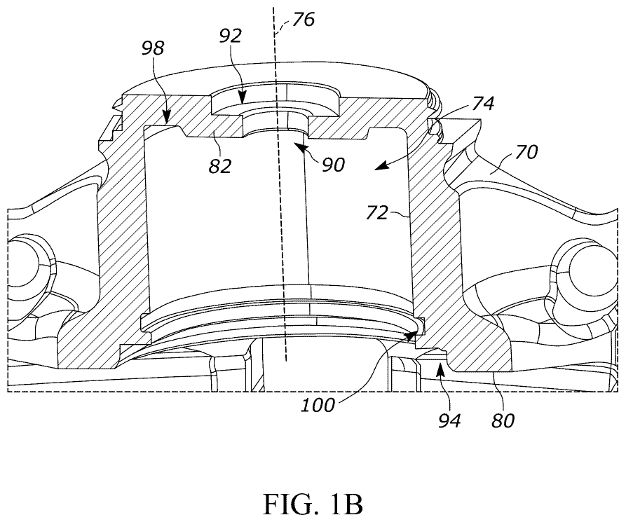

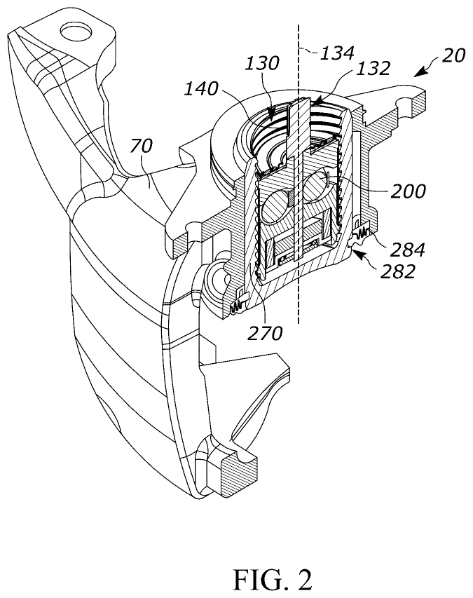

The present invention relates generally to electromechanical brakes and, in particular, relates to a ball-ramp drive for an actuator assembly of the electromechanical brake. FIG. 1A illustrates an example caliper assembly 10 for a vehicle brake in accordance with an aspect of the invention.

The caliper assembly 10 includes an actuator or motor gear unit (MGU) 14 itself including a control assembly 12. The actuator 14 is enclosed in a common, shell-shaped housing 16. The actuator 14 is secured to a caliper housing 70 of a caliper housing assembly 20. The control assembly 12 includes a controller for controlling operation of the caliper assembly 10. The caliper housing 70 defines a gap 22 for receiving a brake rotor 30. First and second brake pads BP1, BP2 are provided in the housing 70 on opposite sides of rotor 30. The drive assembly 14 includes a motor 40 for supplying torque to the drive assembly 14 for selectively applying braking force to the brake pads BP1, BP2.

As shown in FIG. 1B, the caliper housing 70 includes an inner surface 72 defining a passage 74 extending along a axis 76. The passage 74 extends from an axial end surface 80 into the housing 70 and terminates at another end surface 82. An opening 90 extends from the end surface 82 away from the passage 74 and out of the housing 70. The opening 90 includes a countersink 92 and the passage 74 includes a countersink 94. An annular recess 98 is formed in the end surface 82 and encircles the axis 76. Another annular recess 100 is formed in the inner surface 72 and is coaxial to the axis 76.

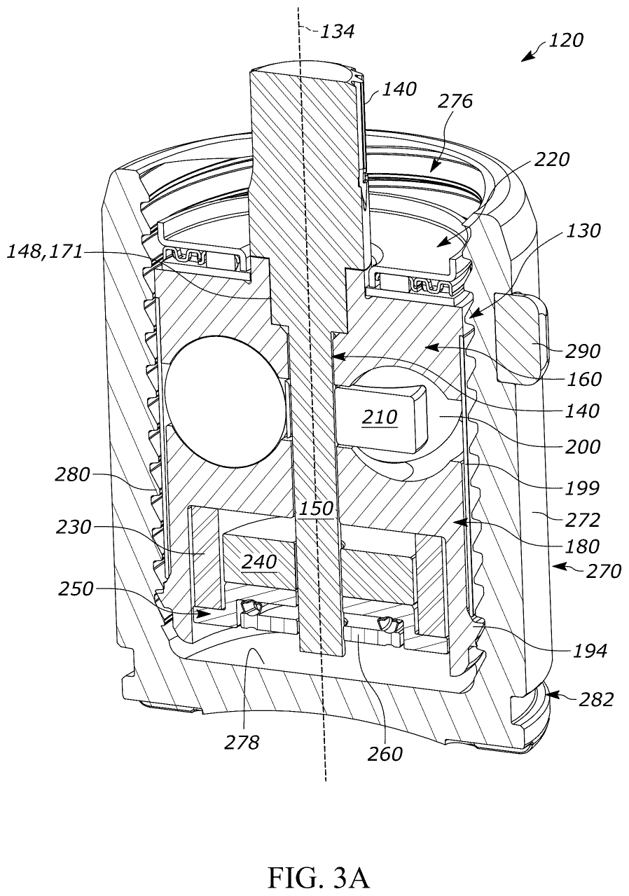

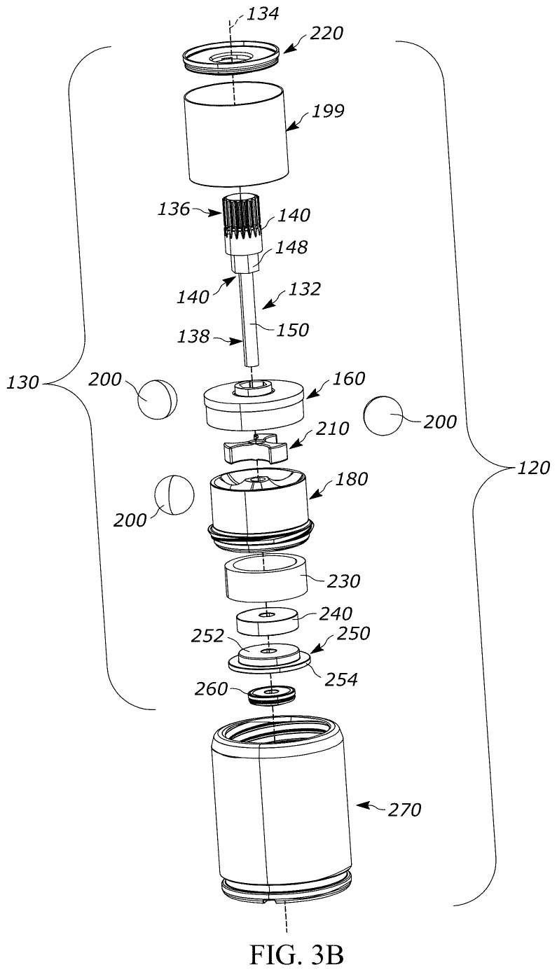

A ball-ramp drive 120 (FIGS. 3A-3B) is provided in the passage 74 for selectively applying braking force to the brake pads BP1, BP2. The ball-ramp drive 120 includes a ball ramp assembly 130 and a cooperating nut 270. The ball ramp assembly 130 includes a drive shaft 132 that extends along a centerline or axis 134 from a first end 136 to a second end 138. The shaft 132 includes a head 140 and a body 142 extending longitudinally therefrom. The body 142 includes a splined portion 148 extending from the head 140 and a smooth portion 150 extending from the splined portion.

The shaft 140 is coupled via a gear train (not shown) and a splined connection to the motor 40 to enable torque transmission from the motor to the shaft 132. To this end, the shaft 140 can be directly connected to the output of the motor 40, for example, by a splined connection (not shown). Alternatively, a gear train (not shown) can be provided to supply a torque transmission path from the output of the motor 40 to the head 140. In any case, the motor 40 controls rotation of the shaft 132 to thereby control the application and release of the vehicle brake, as will be discussed.

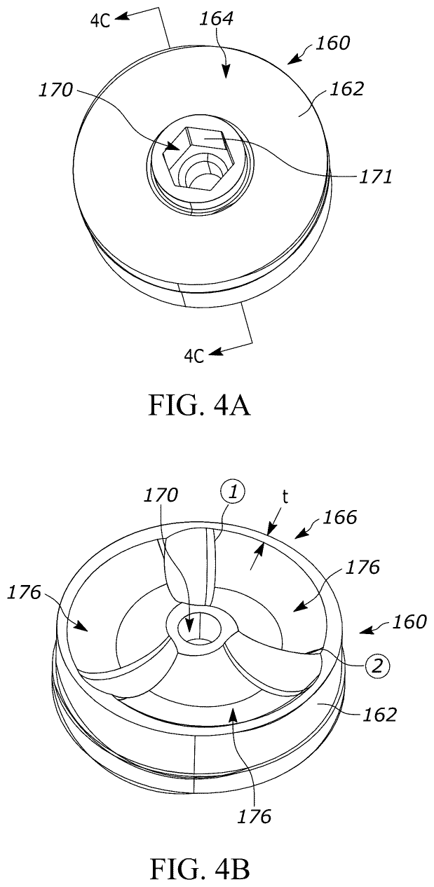

The ball ramp assembly 130 further includes first and second ball ramps 160, 180, a ball ramp spacer 199, bearing balls 200, and a cage 210 for the bearing balls. The bearing balls 200 are spherical and can be formed from a durable material, such as metal. As shown in FIGS. 4A-4B, the first ball ramp 160 has an annular base 162 extending from a first end 164 to a second end 166. A central passage 170 extends entirely through the base 162. A spline or keyway 171 is formed along the central passage 170 extending between the ends 164, 166. Ramps 176 extend into the base 162 and circumferentially about the central passage 170. The ramps 176 incline in a direction extending circumferentially about the central passage 170. In other words, the ramps 176 extend helically into the base 162.

In particular, each ramp 176 extends in a circumferential direction between a start or home position \textcircled{1} and an end position \textcircled{2}. The radial thickness t of the ramp 176 decreases in the direction extending from the position \textcircled{1} to the position \textcircled{2}. That said, not only does the ramp 176 become shallower when moving toward the position B it also becomes narrower. In any case, the contour (changing depth) of the ramps 176 dictates the “lead” of the ramps—the axial travel distance the ball ramp 160 moves with one full rotation.

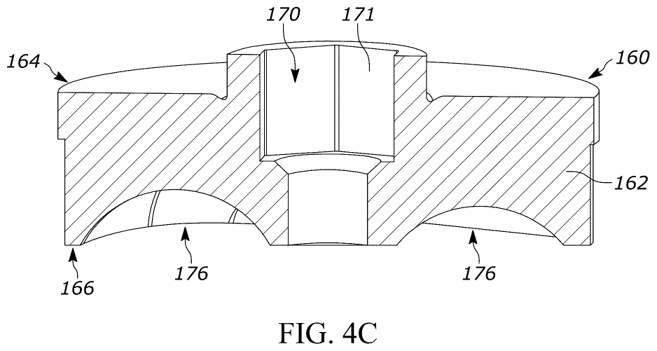

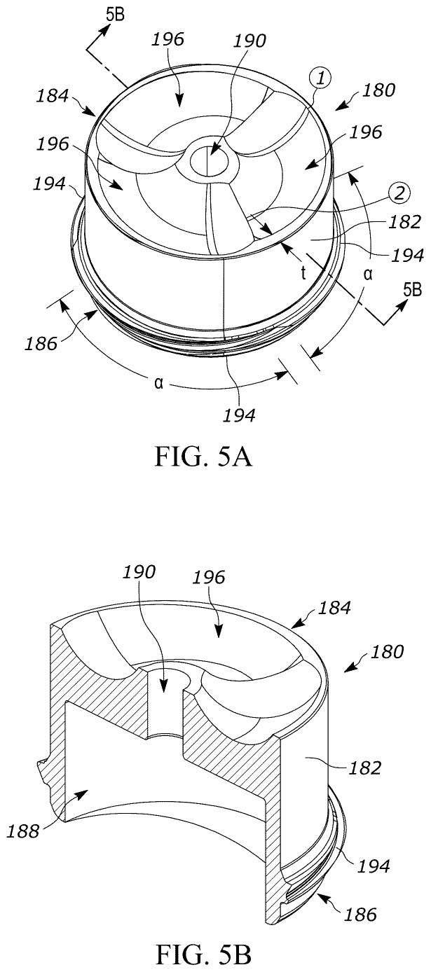

As shown in FIGS. 5A-5C, the second ball ramp 180 includes an annular base 182 extending from a first end 184 to a second end 186. A recess 188 extends from the second end 186 towards the first end 184 and terminates prior to the first end at an axial inner surface 189. A central passage 190 extends through the base 182 from the first end 184 to the recess 188. Ramps 196 extend into base 182 and circumferentially about the central passage 190. The ramps 196 incline in a direction extending circumferentially about the central passage 190. It will be appreciated that the number of ramps 196 will be equal to the number of ramps 176, and that the ramps 196 are identical to the ramps 176, e.g., the locations of the positions \textcircled{1}\textcircled{2}, depth, lead, etc.

Threads 194 extend circumferentially about the base 182 from the second end 186 towards the first end 184. Referring specifically to FIG. 5C, the threads 194 are configured as multiple, independent threads that start at the same longitudinal position—but different circumferential positions—at the second end 186 of the base 182. In other words, threads 194 are formed as individual, multi-start threads instead of a single start thread extending multiple revolutions around the base 182 from the second end 186 and winding towards the first end 184. That said, the group of threads 194 in total extend less than 360° around the base 182. In one example, each thread 194 extends about 120° around the base. In another example shown in FIG. 5C, each thread 194 extends over an arc α of about 90° to about 100° around the base 182. The threads 194 therefore do not overlap one another in the circumferential direction and therefore, all threads 194 in total circumscribe less than 360 degrees around the base 182.

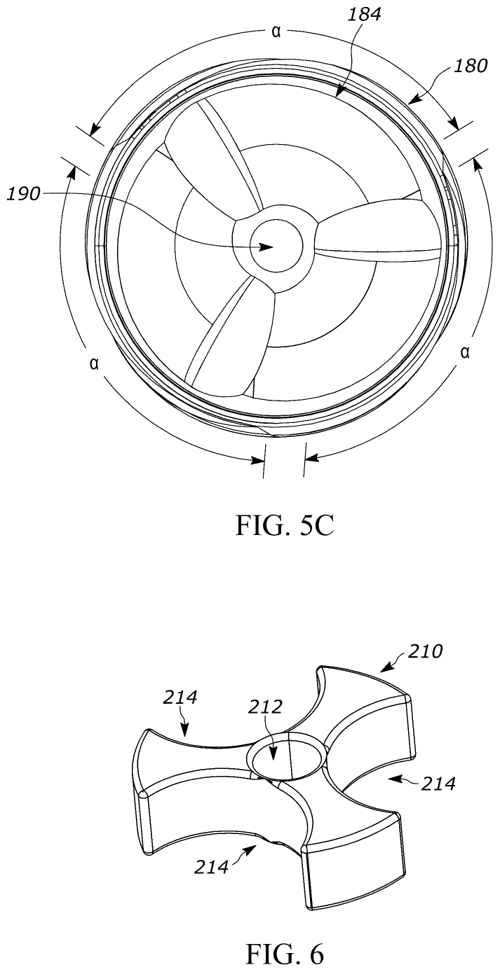

Turning to FIG. 6, the cage 210 includes a central passage 212. Lateral passages 214 are positioned around the central passage 212 and extend entirely through the cage 210. In one example, the cage 210 includes three lateral passages 214 substantially equally spaced apart from one another in the circumferential direction about the central passage 212. In this manner, the cage 210 is generally ring-shaped at its center with multiple, generally T-shaped projections extending radially therefrom in a symmetric arrangement such that the bearing balls 200 are maintained equidistant from each other.

Returning to FIGS. 3A-3B, the ball ramp assembly 130 further includes a thrust bearing 220 (e.g., a ball thrust bearing or needle roller thrust bearing), a spring 230, a spacer 240, an adapter 250, and a preload bearing 260. The spring 230 can be, for example, a compression spring. The spacer 240 is ring-shaped. The adapter 250 has a ring-shaped base 252. A flange 254 extends radially from the base 252. A recess 256 extends into the bottom (as shown) of the base 252.

The nut 270 is cylindrical and includes an outer surface 272 and an inner surface defining a central passage 276. The central passage 276 extends along the length of the nut 270 and terminates at an end wall 278. That said, the nut 270 is closed at one end. Threads 280 are formed along the inner surface 274 and extend substantially the entire length thereof. An annular recess 282 extends around the nut 270.

When the ball ramp assembly 130 is assembled (FIG. 3A), the first and second ball ramps 160, 180 are positioned within the central passage 276 of the nut 270. In particular, the second ball ramp 180 is positioned closer to the end wall 278 with the threads 194 of the second ball ramp engaged with the threads 280 on the nut. In one example, a fast lead connection at the mating threads 194, 280 is established between the second ramp 180 and the nut 270.

By “fast lead connection” it is meant that the lead of the mating threads 194, 280 yields a relatively high stroke of the nut for a relatively small rotation of the second ball ramp. With this in mind, a lead of the threads 280 of the nut 270 is multiple times larger, e.g., about 2 to about 6 times larger, than the lead of the ball ramps 176, 196 on the first ramp 160 and the second ramp 180. In one example, the ball ramps 176, 196 have a lead of about 4 mm and the threads 194 on the second ramp 180 and on the nut 270 have a lead of about 20 mm. The advantages of this construction are outlined below.

In any case, the recess 188 faces towards the end wall 278 of the nut 270 and the ramps 196 face away from the end wall 278. The bearing balls 200 are positioned within the ramps 196 so as to be arranged circumferentially around the central passage 190 of the second ramp 180. The cage 210 is aligned with the second ramp 180 to position the bearing balls 200 within the lateral passages 214. This aligns the central passages 190, 212.

The first ramp 160 is aligned with the cage 210 such that the passages 170, 190, 212 are aligned and the bearing balls 200 positioned within the ramps 176 of the first ramp. The thrust bearing 220 is positioned between the first end 164 of the first ramp 160 and the inner surface 82 of the caliper housing 70. That said, the bearing balls 200 are held axially by the ramps 160, 180 and radially by the bearing cage 210 but permitted to roll on ramps 176, 196.

The shaft 132 extends through the aligned passages 170, 190, 212 such that the splined extension 140 of shaft 132 is positioned within the countersink 92 in the caliper housing 70 and the splined portion 148 engages the keyway 171 on the first ramp 160. The shaft 132 extends through the aligned passages 170, 190, 212 to a position in proximity with the end wall 278 and longitudinally within the recess 188 in the second ramp 180.

The compression spring 230, spacer 240, and adapter 250 are positioned within the recess 188 of the second ramp 180 over the smooth portion 150 of the shaft 132 between the axial extent of the smooth portion and the central passage 190 in the second ramp. In particular, the compression spring 230 encircles the smooth portion 150 of the shaft 132 and abuts the inner surface 189. The spacer 240 is positioned within the compression spring 230 encircling the smooth portion 150 of the shaft 132. The adapter 250 is positioned over the smooth portion 150 of the shaft 132 with the base 252 abutting the spacer 240 and the flange 254 abutting the end of the compression spring 230.

A preload bearing 260 is positioned over the end of the smooth portion 150 and within the recess 256 in the adapter 250. The clip 262 is secured to the end of the shaft 132 abutting the preload bearing 260. In this manner, the compression spring 230 is compressed between the adapter 250 and the second ball ramp 180 in order to exert a preload force on the second ramp in a direction extending towards the first ramp 160 (upwards as shown). The second ramp 180 is therefore biased in a direction towards the first ramp 160. In this manner, the components 230, 240, 250 cooperate to exert a preload force on the second ramp 180, on the bearing balls 200 and on the first ramp 160.

As noted, the head 140 of the shaft 132 extends axially beyond the countersink 92 in the housing 70. A spacer 290 is positioned over the head 140 and abuts the bottom (as shown) of the countersink 92. A clip 300 is secured to the head 140 and abuts the spacer 290. This configuration, in combination with the connection between the head 140 and the motor 40, results in the shaft being rotatable relative to the caliper housing 70 but being prevented from moving axially relative to the caliper housing.

The ball-ramp assembly 130 and nut 270 are positioned within the passage 74 of the caliper housing 70 and aligned with the first brake pad BP1. The head 140 of the shaft 132 is coupled to the output of the motor 40 (either directly or indirectly) to enable torque transmission therebetween. With this in mind, the ball-ramp assembly 130 is configured such that rotation of the shaft 132 results in axial movement of the nut 270 along the axis 134 and along the inner, cylindrical running surface 72 of the caliper housing 70. Axial movement of the nut 270 controls movement of the first brake pad BP1 towards and away from the rotor 30, as will be discussed.

An excluder 284 having a bellows-like design is provided in annular recess 100. The excluder 284 is also connected to the nut 270 at the recess 282 such that the seal is pulled apart or squeezed together during axial displacement of the nut. A key 290 pressed into the exterior of the nut 270 and extending radially therefrom provides an additional interface between the nut 270 and the inner surface 74. To this end, the key 290 cooperates with an axially extending channel (not shown) in the inner surface 74 to prevent rotation of the nut 270 relative to the housing 70, thereby restricting movement of the nut to along [not about] the axis 134. That said, the nut 270 is initially spaced from the first brake pad BP1 during brakes off operation of a moving vehicle 20.

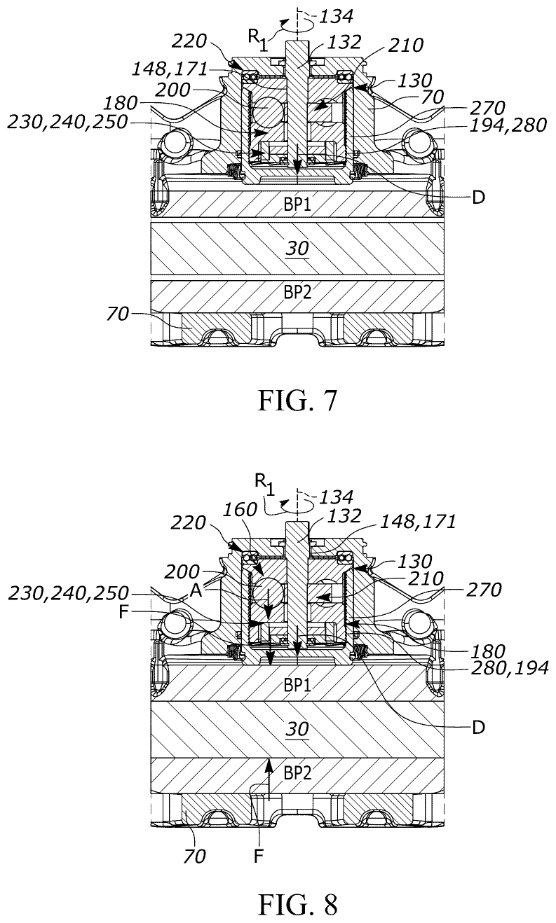

In operation, and referring to FIG. 7, the vehicle operator depresses the brake pedal (not shown) or the vehicle autonomously initiates a braking operation. In either case, the vehicle controller (control assembly 12) actuates the motor 40, which delivers torque to the shaft 132 in a known manner. In response, the shaft 132 rotates about the axis 134 in the manner R₁ (clockwise as shown) but, due to the ball ramp assembly 130 design and assembly within the caliper housing 70, is prevented from translating axially along the axis.

Due to the splined connection 148, 171 between the shaft 132 and first ramp 160, rotation of the shaft in the manner R₁ results in rotation of the first ramp in the manner R₁. The bearing balls 200 are biased into engagement with the ramps 176 in the first ramp 160 [at position \textcircled{1}] and at this point in time there are minimal or no reaction forces on the nut 270 provided by the brake pad BP1 due to a gap existing between the nut/piston 270 and brake pad BP1 and any gap existing between the caliper housing 70 fingers and the brake pad BP2. Consequently, the entire ball ramp assembly 130 rotates as a single unit via the threaded interface 194, 280 relative to the nut 270 in the manner R₁. More specifically, the discrete/individual multi-start threads 194 on the second ramp 190 rotate relative to the matching multi-start threads 280 on the nut 270, which is rotationally fixed due to the key 290.

In other words, both the first and second ramps 160, 180, the bearing balls 200, the cage 210, the spring 230, the spacer 240, and the adapter 250 all rotate together with the shaft 132 in the manner R₁ relative to the nut 270. Rotation of the ball ramp assembly 130 in the manner R₁ causes the nut 270 to move through the threads 194, 280 axially in the direction D towards the brake pad BP1. This movement occurs when there is zero or minimal load between the nut/piston 270 and the first brake pad BP1, such that the torque required to move the nut/piston 270 is less than the torque required to overcome the preset torque generated by the compression spring 230.

Since the second ramp 180 and nut 270 have a fast lead connection at the threads 194, 280, less rotation of the second ramp 180 is needed in order to axially advance the nut 270 relative to the second ramp and towards the brake pad BP1 to eliminate the gap existing between the nut/piston 270 and the brake pad BP1 and the gap existing between the caliper housing 70 fingers and brake pad BP2. Consequently, the shaft 132 and the nut 270 have an advantageous, cooperative configuration that helps maximize the efficiency in converting rotation of the shaft to axial movement of the nut. To this end, a relatively lower pitch for the threaded connection 194, 280 than that used herein would require more rotation of the second ramp 180 before the nut 270 reached the same degree of axial movement relative to the second ramp.

With this in mind, the nut 270 rapidly advances to close the gap with the brake pad BP1 and brake pad BP2 and ultimately causes both brake pads BP1 and BP2 to engage the rotor 30 to begin applying relatively low braking loads (indicated at F in FIG. 8) thereto. In other words, at zero or low clamp force, the fast lead connection at the threads 194, 280—which is a sliding friction interface-is used to advance the nut 270. That said, this applies reaction forces to the nut 270, which are transferred back through the ball ramp assembly 130 until torque is applied to the shaft 132.

At some point, the load on the first brake pad BP1 (and therefore the reaction forces on the nut 270) reaches a predetermined [relatively low] amount that is greater than the torque required to overcome the preset torque generated by the compression spring 230. Thereafter, the threaded interface 194, 280 between the second ramp 180 and the nut 270 “locks” to prevent further relative rotation between the second ramp and the nut because further rotation at this interface requires higher torque than the torque required to rotate the first ball ramp 160 with respect to the second ball ramp 180.

When this occurs, and still referring to FIG. 8, further rotation of the first ramp 160 with the shaft 132 via the keys 148, 171 in the manner R₁ causes the first ramp and bearing balls 200 to orbit the axis 134 by moving with the rotating first ramp, although at a different speed and rotation angle. The bearing balls 200 are initially met with frictional/sliding resistance to orbital movement by the ramps 176, 196 due to the pre-load on the second ramp 180 by the compression spring 230. Continued rotation of the shaft 132 eventually requires a torque level that is higher than the preset torque required to allow the ball ramp 130 to function and for the threaded interface 194, 280 to lock. This causes the second ramp 180 to lock to the nut/piston 270 via the threaded interface 194, 280 and thus, the first ramp 160 to start rotating with respect the second ball ramp 180 via the bearing balls 200 which start rolling on the ramps at ½ the rotation speed and angle that the first ramp 160 rotates.

More specifically, the bearing balls 200 roll up and along the ramps 176, 196 from the position \textcircled{1} to the position \textcircled{2}. Due to the contour of the ramps 196, and the first ramp 160 being axially fixed between the bearing balls 200 and the thrust bearing 220, the second ramp 180 is urged in a direction away from the first ramp in a direction A as the bearing balls roll along the ramps. It will be appreciated that due to the lead of the nut 270 being larger than the lead of the ball ramps 176, 196, rotation of the shaft 132 results in the stroke of the nut 270 being multiple times greater than the stroke of the ball ramp. This movement of the nut 270 to the extended position applies additional clamp load F to the rotor 30 via the brake pads BP1 and BP2. In one example, a clamp load of about 100 kN can be achieved with the ball ramp assembly 130.

In response to the reaction forces acting inside the actuator assembly 10 and the caliper housing 70, the second brake pad BP2 is thereby also placed on the rotor 30 in a known manner. The application of the brake pads BP1, BP2 on the rotor 30 is indicated generally by the opposing arrows F in FIG. 8. The motor 40 is controlled to maintain the desired brake apply force F on the rotor 30, which can be determined by monitoring feedback currents on the motor 40.

Once the braking operation is complete, the controller actuates the motor 40 to rotate in the opposite direction to thereby rotate the shaft 132 in the direction opposite the direction R₁. It is understood that, by operating the motor 40, the nut 270 can be moved into a retracted position, which is associated with lifting the first brake pad BP1 and the second brake pad BP2 off the rotor 30. More specifically, when the motor 40 is commanded to rotate in the opposite direction, the bearing balls 200 orbit the shaft 132 with the first ramp 160 relative to the stationary second ramp 180 to allow the bearing balls to roll down the ramps 176, 196. This causes the second ramp 180, bearing balls 200, and nut 270 to retract together away from the brake pad BP1 until the bearing balls 200 are returned to their initial condition within both sets of ramps 176, 196 (the ball ramp assembly 130 is fully retracted).

At this point, additional rotation of the shaft 132 in the opposite direction causes the nut 270 to retract relative to the stationary second ramp 180 through the fast lead connection at the threads 194, 280. That said, for the same reasons mentioned above, this retraction is facilitated/expedited by the fast lead connection 194, 280 in that relatively less rotation of the shaft 132 in the opposite direction is needed to achieve a desired retraction or lift off of the nut 270 from the brake pad BP1. In one example, the lift off or gap between the axial end of the nut 270 and the brake pad BP1 is about 0.60 mm. It will be appreciated that when the actuator assembly 10 includes a pair of opposing pistons (not shown) for engaging the respective brake pads BP1, BP2, each of the respective nuts 270 will be lifted off the respective brake pad by about 0.60 mm (for a total lift off of about 1.2 mm liftoff).

It will be appreciated that as the brake pads BP1, BP2 wear over time the overall gap between the brake pads BP1 and BP2 would normally increase over time.

With this in mind, the position to which the nut 270 returns will advantageously, automatically adjust over time. In particular, as the brake pads BP1, BP2 wear, the return position of the nut will drift/shift in the direction towards the brake pad BP1 to ensure that the travel distance needed to apply the brake is constant or substantially constant over time.

Automatic adjustment for brake pad BP1 and/or BP2 wear occurs when the brake is retracted. As discussed above, once the bearing balls 200 and the second ball ramp 180 return to the home/start position with first ball ramp 160, additional rotation of the ball ramp assembly 130 as a whole, occurs via the threaded interface 194, 280 at essentially zero load. Once minimal current draw is detected at the motor 40, the controller 12 determines that nut/piston 270 retraction occurs via the fast threaded interface 194, 280, and thus, the controller commands a rotation targeting a preset gap between brake pads BP1, BP2 and the rotor. In this manner, the nut/piston 270 position is adjusted via the threaded interface 194, 280 in response to pad wear.

More specifically, the controller 12 can determine the degree of rotation of the shaft 132 needed to achieve a desired brake apply force when the brake pads BP1, BP2 are new and “memorize” an initial nut 270 retraction position needed to achieve the desired lift off. As the brake pad(s) BP1, BP2 wear, the controller 12 can adjust rotation of the shaft 132 during brake release to gradually retract the nut 270 to a new return position that is further from the second end 138 of the shaft 132 but the same distance from the brake pad BP1 to maintain constant brake apply and lift off distances throughout the useful life of the brake pad(s) BP1, BP2.

The ball ramp drive of the present invention is advantageous in that the fast lead connection allows the nut to more quickly retract relative to the brake pad to create a greater air gap between the nut and brake pad in the same or less time required by brake actuators utilizing ball nut assemblies. In other words, zero drag can be achieved much more easily compared to existing brake systems that don't rely on different thread pitches between components because the ball ramp drive of the present invention is able to generate much more gap without sacrificing (i.e. increasing) apply time vs existing brake systems.

Along the same lines, the fast lead connection also allows the nut to more quickly extend relative to the brake pad to move across the air gap and begin applying the brake at a faster rate. To this end, by configuring the lead of the threads on the nut to be multiple times larger than the lead of the threads on the second ramp, rotation of the ball ramp assembly via the second ramp results in greater axial travel in the same/less time compared to when the leads are the same as the ball ramp lead. Thus the nut can be retracted to generate a large air gap between pads BP1, BP2 and the rotor which reduces drag between the nut and the brake pad to help improve both longevity and performance.

The present invention is also advantageous in that relatively less rotation of the second ramp relative to the nut is needed in order to apply and support the desired clamp load on the brake pad. To this end, current actuators rely on more than 360°of continuous thread engagement between the ball nut/ball ramp and piston in order to both apply and hold the clamp load. By advantageously configuring the second ramp of the present invention to have discrete, multi-start threads with a fast lead that is a multiple of the ball ramp drive can more quickly apply the clamp load while still being able to hold/maintain the load necessary to brake the vehicle per the commanded clamp load.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A ball-ramp assembly for a vehicle brake having brake pads and a rotor, comprising:
a shaft rotatable about an axis;
a ball ramp having a first ramp rotatable with the shaft and a second ramp aligned with the first ramp;
bearing balls positioned between and engaging the first and second ramps for transforming rotation of the first ramp into axial movement of the second ramp; and
a nut having a threaded connection with the second ramp with a lead of the threads of the nut being multiple times larger than a lead of the ball ramp, wherein the ball ramp has a first condition in which rotation of the shaft rotates the whole ball ramp assembly to axially move the nut relative to the ball ramp for engaging the brake pads with the rotor and a second condition thereafter in which rotation of the shaft rotates the first ramp relative to the second ramp to axially move the second ramp and nut together relative to the first ramp for applying the vehicle brake.

2. The ball-ramp assembly as recited in claim 1, wherein the lead of the threads of the nut is about 2 to about 6 times larger than the lead of the ball ramp.

3. The ball-ramp assembly as recited in claim 1, wherein the second ramp and the nut have a fast lead connection.

4. The ball-ramp assembly as recited in claim 1, wherein the threads on the second ramp and the threads on the nut each comprises matching multi-start threads.

5. The ball-ramp assembly as recited in claim 4, wherein collectively the multi-start threads formed on the second ramp and the nut extends less than 360° in total around the respective second ball ramp and interfaces less than 360° with the nut threads.

6. The ball-ramp assembly as recited in claim 4, wherein the multi-start threads comprise three-start threads that each extends less than 120° around the respective second ball ramp and the nut.

7. The ball-ramp assembly as recited in claim 1, further comprising a device for biasing the second ramp towards the first ramp.

8. The ball-ramp assembly as recited in claim 7, wherein the biasing device comprises:
a spring encircling the shaft and provided on the second ramp and;
an adapter encircling the shaft and having a fixed position along the shaft for compressing the spring between the adapter and the second ramp.

9. The ball-ramp assembly as recited in claim 8, further comprising a clip secured to the shaft for fixing the position of the adapter along the shaft.

10. The ball-ramp assembly as recited in claim 1, further comprising a bearing cage positioned between the first and second ramps and having lateral passages for receiving the bearing balls.

11. A ball-ramp assembly for a vehicle brake having brake pads and a rotor, comprising:
a shaft rotatable about an axis;
a ball ramp having a first ramp rotatable with the shaft and a second ramp aligned with the first ramp;
bearing balls positioned between and engaging the first and second ramps for transforming rotation of the first ramp into axial movement of the second ramp; and
a nut having a matching, multi-start threaded connection with the second ramp with a lead of the threads of the nut being about 2 to about 6 times larger than a lead of the ball ramp, wherein the ball ramp has a first condition in which rotation of the shaft rotates the whole ball ramp assembly to axially move the nut relative to the ball ramp for engaging the brake pads with the rotor and a second condition thereafter in which rotation of the shaft rotates the first ramp relative to the second ramp to axially move the second ramp and nut together relative to the first ramp for applying the vehicle brake.

12. The ball-ramp assembly as recited in claim 11, wherein the second ramp and the nut have a fast lead connection.

13. The ball-ramp assembly as recited in claim 11, wherein collectively the multi-start threads formed on the second ramp and the nut extends less than 360° in total around the respective second ball ramp and interfaces less than 360° with the nut threads.

14. The ball-ramp assembly as recited in claim 11, wherein the multi-start threads comprise three-start threads that each extends less than 120° around the respective second ball ramp and the nut.

15. The ball-ramp assembly as recited in claim 11, further comprising a device for biasing the second ramp towards the first ramp.

16. The ball-ramp assembly as recited in claim 15, wherein the biasing device comprises:
a spring encircling the shaft and provided on the second ramp and;
an adapter encircling the shaft and having a fixed position along the shaft for compressing the spring between the adapter and the second ramp.

17. The ball-ramp assembly as recited in claim 16, further comprising a clip secured to the shaft for fixing the position of the adapter along the shaft.

18. The ball-ramp assembly as recited in claim 11, further comprising a bearing cage positioned between the first and second ramps and having lateral passages for receiving the bearing balls.
